(19) United States
(12) Patent Application Publication
(10) Pub. No.: US 2025/0313043 A1
(43) Pub. Date: Oct. 9, 2025

(54) TIRES WITH IMPROVED AERODYNAMICS

(71) Applicant: Ching-Tang CHEN, Taichung (TW)

(72) Inventor: Ching-Tang CHEN, Taichung (TW)

(21) Appl. No.: 18/640,129

(22) Filed: Apr. 19, 2024

Related U.S. Application Data
(63) Continuation-in-part of application No. 18/630,131, filed on Apr. 9, 2024.

(51) Int. Cl. B60C 11/03

(52) U.S. Cl. CPC B60C 11/03; B60C 2011/0355; B60C 2200/12

(57) ABSTRACT

A bicycle tire designed to substantially reduce aerodynamic drag through several innovative design features, including minimized venting flash on the sidewall, engraved marking on the tire tread, elimination of the rim line, reduced tread gap at the tire edge, and/or the application of aerodynamic dimples on both tread or sidewall. These features collectively improve the tire's performance by enhancing airflow and reducing resistance.

### CROSS-REFERENCE TO RELATED APPLICATIONS

This application is a Continuation-in-Part of U.S. patent application Ser. No. 18/630,131, filed on Apr. 9, 2024, entitled “TIRES WITH IMPROVED ROLLING EFFICIENCY.” The contents of the aforementioned application are hereby incorporated by reference in their entirety.

### BACKGROUND OF THE INVENTION

### Field of the Invention

The present inventions relate generally to pneumatic tires, and more specifically to a bias tire for bicycle with improved aerodynamics.

### Description of Related Art

Bias tires are a type of tire construction that differs from the more modern radial tires. In bias tires, the internal plies or layers of fabric that constitute the tire's structure are arranged at an angle, typically between 30 to 50 degrees, to the direction of travel. This diagonal pattern allows the entire tire to flex more easily, providing a smoother ride over rough surfaces.

However, the traditional designs of bicycle tires do not ensure a smooth transition between the tire and the rim, which can create additional turbulence as air flows from the tire onto the rim. Although modern aerodynamic wheels often feature a more seamless transition that minimizes this disruption, an aerodynamically improved tire that reduce these issues may significantly improve performance, especially at higher speeds.

### SUMMARY OF THE INVENTION

The invention provides an advanced bicycle tire design focused on optimizing aerodynamic properties through specific improvements in tire structure and surface characteristics. While this summary provides a basic overview of the invention and its significant features, it should be understood that this overview is not exhaustive or limiting in nature. The invention is not restricted to the precise configurations and components described herein, as various modifications, variations, and enhancements are possible within the scope of the invention. The summary aims to introduce the concept of the invention and its potential applications, with the understanding that the detailed description and claims that follow more fully elucidate the invention. Therefore, the descriptions and examples in this summary should not be interpreted as limiting the scope of the invention, which is defined solely by the claims.

It is one object of the invention to provide a bicycle tire that performs better by reducing aerodynamic drag but also maintains or enhances other performance aspects such as rolling efficiency or puncture protection. This design is particularly targeted at improving the efficiency and speed of bicycles by addressing traditional aerodynamic flaws in standard tire designs.

In some embodiments of the present invention, the tire is designed with a smooth sidewall that minimizes aerodynamic resistance by reducing turbulent air flow along the sides of the tire. This feature helps in achieving a cleaner and more streamlined air passage, which is crucial for reducing drag.

In some embodiments of the present invention, the tire's section width is engineered to match closely with the rim, ensuring a seamless transition between the tire and the rim. This design reduces gaps that can disrupt airflow, thus further contributing to a reduction in aerodynamic drag.

In some embodiments of the present invention, the tire incorporates a dimpled tread pattern similar to those used in golf balls. These dimples are strategically placed to manage air flow across the tire surface, effectively reducing drag by modifying the boundary layer of air that contacts the tire.

### BRIEF DESCRIPTION OF THE DRAWINGS

The present description will be better understood from the following detailed description read in light of the accompanying drawings.

FIG. 1 is a cross-sectional illustrative view of an exemplary tire according to prior art.

FIG. 2 is a cross-sectional illustrative view of an exemplary tire according to one embodiment of the present invention.

FIG. 3 is a cross-sectional illustrative view of an exemplary tire according to one embodiment of the present invention. FIG. 4 is a cross-sectional illustrative view of an exemplary tire according to one embodiment of the present invention.

FIG. 5a is an illustrative view of an exemplary tire tread according to one embodiment of the present invention.

FIG. 5b is an illustrative view of an exemplary tire tread according to one embodiment of the present invention.

### DESCRIPTION OF THE PREFERRED EMBODIMENTS

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes”, “including”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, the terms “and” and “or” as used herein, including the claims, are intended to be interpreted as inclusive or meaning either or both rather than exclusive or meaning either but not both, unless specifically indicated otherwise or the context clearly dictates otherwise.

The invention pertains to bias tires with improved aerodynamics. These and other aspects of the invention are discussed below with reference to the relevant figures. However, those skilled in the art will readily appreciate that the detailed description given herein with respect to these figures is for explanatory purposes, as the invention extends beyond these limited embodiments.

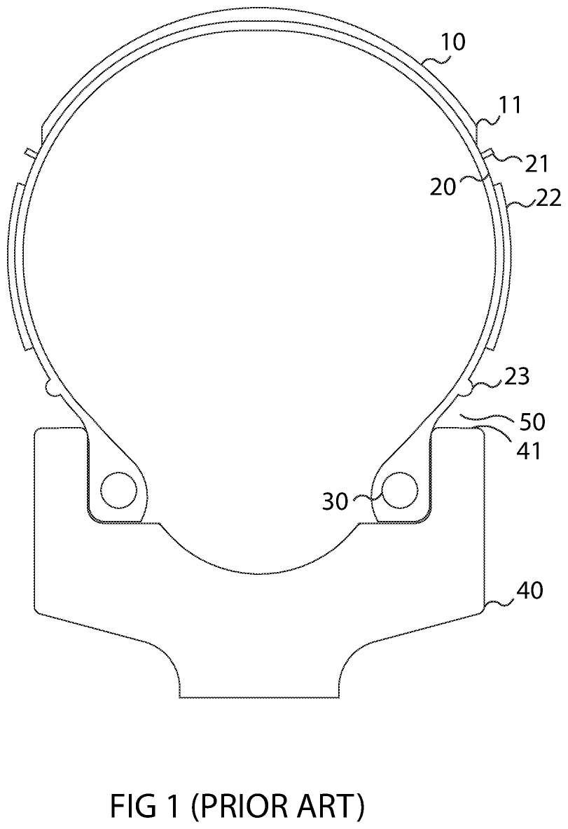

FIG. 1 presents a cross-sectional illustrative view of an exemplary tire according to prior art. This tire consists of the tread 10, sidewall 20, and bead 30. The tire is mounted on the rim 40.

The tread 10 ends at the tread edge 11. The distance between the tread edge 11 and the sidewall 20 is referred hereinafter as the tread gap. Usually, the tread gap is between 1-3 mm for bicycle road tires.

The sidewall 20 has many venting flashes 21. The hair-like venting flashes 21 are usually rubber that can come out of the venting holes in a mold during the vulcanization process. The venting mechanism is crucial for preventing defects caused by trapped air. The height of the venting flash 21 is usually more than 1 mm, and the width of the venting flash 21 is usually between 0.5-2 mm.

The sidewall 20 has the engraving 22, which contains details and text embossed onto the sidewall 20 portion of the mold of a bicycle tire. The engraving 22 may include essential details such as brand and model information, size specifications, and recommended pressure ratings. Additionally, it may feature directional arrows for proper mounting, and compliance marks such as E-Mark.

The sidewall 20 also has the rim line 23 that provides visual indication as to whether the tire has been properly mounted. Proper mounting is crucial for safety, preventing the tire from slipping or blowing off under pressure. It ensures the tire is mounted evenly, providing stable and balanced riding.

In FIG. 1, the gap 50 between a bicycle tire's sidewall 20 and the rim wall 41 can impact aerodynamics. This gap 50 can cause air to become turbulent as it flows over the tire and hits the rim, creating increased drag.

In traditional bicycle tires, several features interfere with airflow, thereby increasing air drag and reducing aerodynamics. The high tread gap, venting flashes 21, sidewall engravings 22, the rim line 23, and the gap 50 all contribute to these disturbances. Each of these elements can disrupt the smooth flow of air around the tire, leading to higher resistance and decreased efficiency during riding. These design aspects, while functional for other purposes, act as obstacles to streamlined airflow, making the tire less aerodynamic.

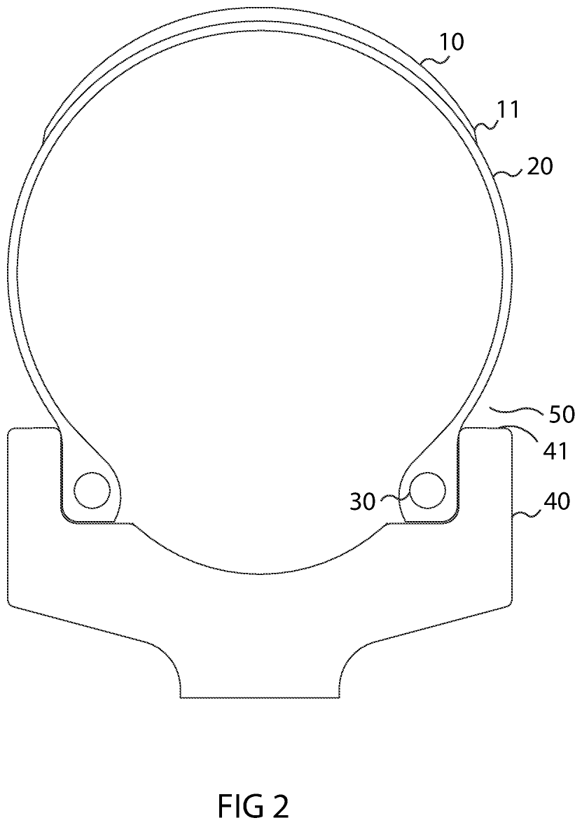

FIG. 2 is a cross-sectional illustrative view of an exemplary tire according to one embodiment of the present invention. In FIG. 2, the tread gap between the tread edge 11 and the sidewall 20 is reduced to improve the aerodynamic. In some embodiments of the present invention, the tread gap is less than 0.5 mm, and preferably between 0.05-0.2 mm.

In some embodiments of the present invention, the venting flashes 21 can be minimized or eliminated to create a smoother sidewall 20. One approach to achieve this is by reducing the height or the width of the venting flash 20. Lowering the profile of the flash helps streamline the sidewall's surface, enhancing the tire's overall aerodynamic properties. In some cases, the number of venting flashes 21 that have height exceeding 4 mm or has width exceeding 0.6 mm is between 0-12. Preferably, there is no venting flash 21 at all on the tire sidewall 20. In some cases, the venting flash 21 is replaced with parting line of the ring mold. In ring molds, the parting line is the line or seam formed where different rim parts of the mold come together. The parting lines can vent air, and they do not protrude as much, which can improve the aerodynamics.

In some embodiments of the present invention, a portion of the original sidewall engraving 22 in FIG. 1 may be moved to the tread 10 of a bicycle tire to help reduce air drag. The depth of the engraving on the tread 10 can be around 0.1-0.3 mm. Preferably, all sidewall engraving 22 in FIG. 1 is moved to the tread 10. By relocating these engravings from the sidewall 20 to the tread 10 area, the tire's sidewalls become smoother, thus minimizing turbulence and airflow disruption, enhancing aerodynamic efficiency. Additionally, placing engravings on the tread 10, where they may have less impact on airflow due to the already existing tread patterns, can be an effective way to maintain necessary tire information without compromising aerodynamic performance. In some embodiments, the size specifications and/or the recommended pressure ratings are moved to be embossed on the tread 10. A person of ordinary skill in the art would appreciate that using machine engraving to emboss the information onto a mold is just one method; alternatives like Electrical Discharge Machining (EDM) are also viable to emboss the information onto the mold. EDM allows for precise and intricate details to be etched onto molds, offering a versatile solution for adding information or designs without direct physical contact that might compromise the mold's integrity.

In some embodiments of the present invention, the rim line 23 in FIG. 1 on the tire is eliminated to enhance aerodynamic performance by creating a smoother sidewall 20. In other instances, the height of the rim line 23 in FIG. 1 is reduced to between 0.05-0.2 mm. In some instances, the rim line 23 in FIG. 1 may be replaced by multiple sub-rim lines parallel to each other and each has a height between 0.05-0.2 mm. Alternatively, a surface treatment can be used on the tire sidewall 20 in place of a protruding rim line 23 in FIG. 1 to serve as a mounting indicator. For example, an EDM (Electrical Discharge Machining) surface treatment can be applied where the rim line 23 in FIG. 1 would typically be. This allows the line to remain visible to the user without protruding from the sidewall 20, thereby maintaining a smoother, more aerodynamically efficient profile.

In some embodiments of the present invention, the bicycle tire's section width is engineered to closely align with the rim dimensions to enhance aerodynamics further. This minimizes the gap 50 between the tire and the rim 40. Using a hookless rim is one method to achieve this. Also, in some cases, ensuring that the tire section width exceeds the rim's outer width by less than 2 mm may also reduce the gap 50.

In some embodiments of the present invention, the tire's section width at the tire's maximum recommended pressure may be about 29.5-31.5 mm with the rim's outer widths of 28-31 mm and inner widths of 22-26 mm. In other embodiments, the tire's section width at the tire's maximum recommended pressure might be about 31.5-33.5 mm with rim's outer widths of 29.5-33 mm and inner widths of 22-27 mm. In other embodiments, the tire's section width at the tire's maximum recommended pressure might be about 34.5-35.5 mm with the rim's outer widths of 29.5-38 mm and inner widths of 22-32 mm.

A person of ordinary skill in the art would recognize that the section width of the tire can be controlled by, for example, mold design, the width of the green tire, the angle at which the tire components are cut, and the overall construction of the tire.

In some cases, the section width of a bicycle tire may increase as the tire carcass and rubber relax due to inflation. This relaxation may take 24 hours at maximum pressure for the tire to settle into its final shape. Hence initially, the tire profile may not be as aerodynamic as designed due to this relaxation process. To address this issue, manufacturers can employ a post-cure inflation technique. This technique involves inflating the tire after the curing process, allowing the tire carcass and rubber to cool down while inflated. This method helps reduce the variance between the tire's initial inflated section width at the maximum tire pressure and its width after 24 hours at the maximum tire pressure (hereinafter, the “24-hour maximum pressure section width variance”). In some embodiments of the present invention, the 24-hour maximum pressure section width variance can be less than 1 mm, and preferably less than 0.5 mm. This approach ensures that the tire maintains a more consistent and aerodynamically favorable profile from the outset.

In the current design approach, achieving the goal of reducing the gap between the tire and the rim 40 involves closely matching the tire's width to that of the rim's outer rim width. This proximity may result in putting a tire on a wider rim size compared to the rim size recommended by the ISO 5771. Putting a tire on a wider rim size may subject the tire's bead 30 to greater forces, particularly when the rim 40 is a hookless rim. As a result, these increased forces may require the use of stronger materials for the bead to ensure durability and maintain structural integrity.

For example, the material of the tire bead 30 can be made from flexible material such as aramid (Kevlar), carbon fiber, Zylon (PBO), a composite of aramid and carbon fiber, or a composite of aramid and PBO. These materials are known for their strength and flexibility, which can enhance the durability and performance of the tire under various conditions. In some cases, the bead 30 is made by winding together from two aramid strands and then wound them into 7-14 loops to create the final product. This technique leverages the strength and flexibility of aramid fiber, enhancing the structural integrity and performance of the material used in various applications. Preferably, the aramid construction is two strands and then wound into 10-12 loops with winding overlapping between 100-450 mm. For a carbon fiber bead 30, the yarn type of the carbon fiber strand may have linear weight about 6000-12000 dtex and the single strand is wound 7-10 loops with winding overlapping between 100 to 450 mm. To further help with the binding of the bead 30 with the tire carcass, the bead may be coated with cover coat adhesive that bonds rubber compounds to the bead fiber during vulcanization.

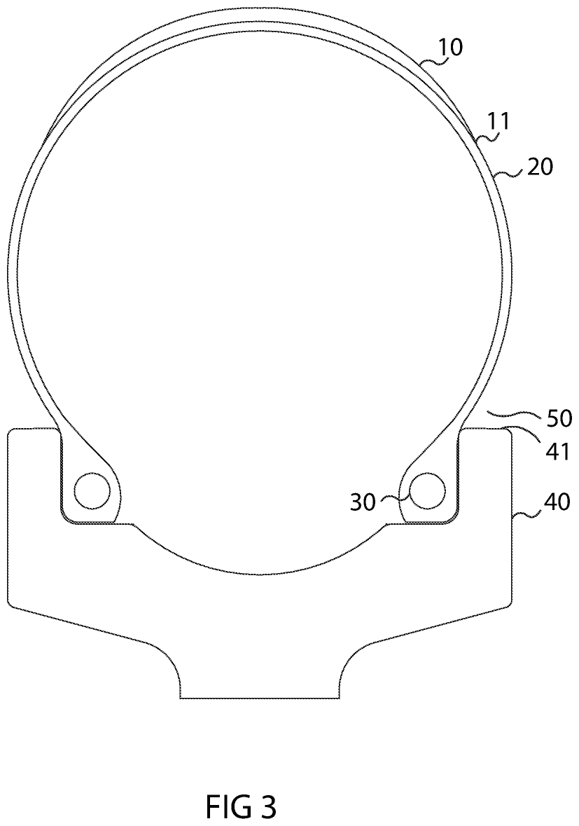

FIG. 3 is a cross-sectional illustrative view of an exemplary tire according to one embodiment of the present invention. In FIG. 3, the tread edge 11 extends seamlessly to meet the sidewall 20, eliminating any gap between the tread 10 and sidewall 20. This design improves the aerodynamics of the tire by creating a smooth surface that reduces air turbulence around the tire edges. As air flows more smoothly over the tire surface, it minimizes drag and enhances the overall efficiency and performance of the tire, particularly at high speeds. This seamless integration is beneficial for reducing aerodynamic resistance.

FIG. 4 is a cross-sectional illustrative view of an exemplary tire according to one embodiment of the present invention. In FIG. 4, a wing-like structure 24 is depicted as filling the gap between the tire sidewall 20 and the rim wall 41. This design improves the aerodynamics of the tire-rim combination by minimizing the air turbulence that can occur in the gap, thus reducing drag and enhancing performance. Additionally, this wing serves a dual purpose by acting as a buffer. It protects both the tire and the rim against impacts by preventing direct contact between the rim and the ground or other objects. This added protection helps to extend the lifespan of both the tire and the rim and improves safety during operation.

In some embodiments of the present invention, the wing-like structure 24, only partially fills the gap between the tire sidewall 20 and the rim wall 41. Preferably, it occupies at least 40% of this space. The material chosen for this wing-like structure 24 may be rubber or other type of elastomer, which can vary in hardness to suit different applications. The hardness of the rubber used may range from 35 to 75 on the Shore A scale, providing a balance between flexibility and resilience. In some cases, the total weight of the wing-like structure 24 is between 7-60 gram. Preferably, it is between 9-20 grams.

In other specific embodiments, the rubber may be a type of foam rubber, chosen for its lighter weight and cushioning properties. In some cases, the average density of this foamed rubber of the wing-like structure 24 may approximately be between 0.20 to 0.75. This lighter, air-filled rubber not only contributes to the structural buffering and protective functions but also enhances the overall efficiency of the tire-rim assembly by reducing weight without sacrificing strength or durability.

Preferably, the wing-like structure 24 may be vulcanized together with the tire to achieve strong bounding between the wing-like structure 24 and the sidewall 20. Alternatively, the wing-like structure 24 may be glued onto the tire sidewall 20 after the tire is vulcanized. In such case, the material of the wing-like structure 24 may be any kind of elastomer such as TPE, TPU, EVA foam, silicone foam, polyurethane foam, and closed-cell foam.

In FIG. 4, the depicted wing-like structure 24 is generally triangular in shape, with its base positioned proximal to the rim wall 41. In certain embodiments, the base of the wing-like structure 24 measures approximately 1-3.5 mm in width, while the height of the triangular shape ranges from about 2-15 mm. Preferably, the wing-like structure 24 measures approximately 2-3.5 mm in width, while the height of the triangular shape ranges from about 3-7 mm. This specific configuration is designed to enhance aerodynamic efficiency and can be adjusted or modified according to specific performance requirements or manufacturing capabilities.

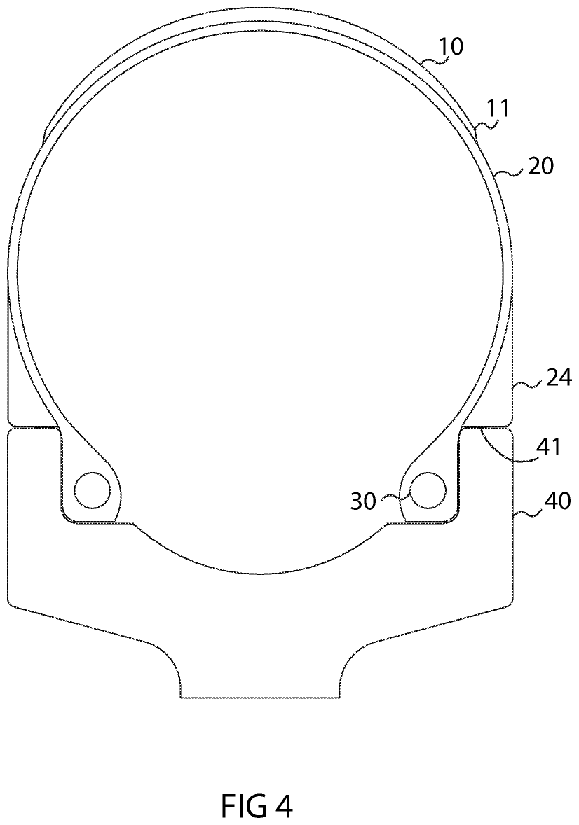

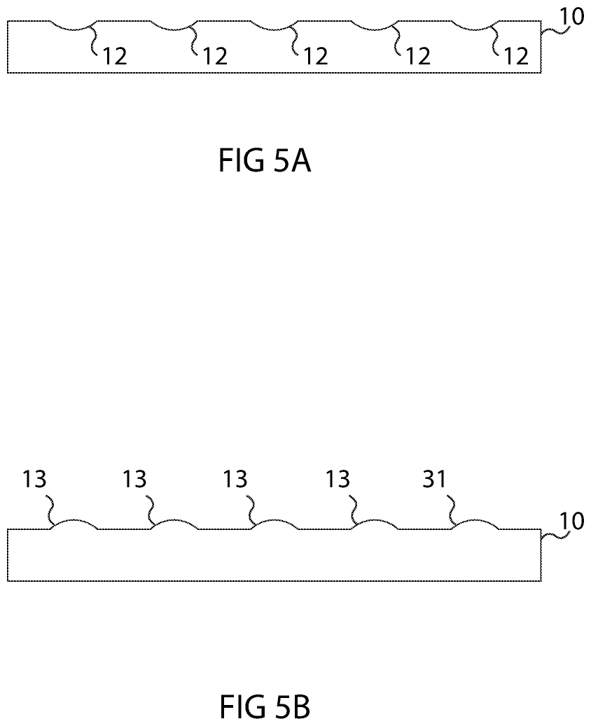

FIG. 5A and 5B are illustrative views of an exemplary tire tread 10 according to some embodiments of the present invention. In FIG. 5A, applying several dimples 12 similar to that found on golf balls onto the surface of bicycle tire tread 10 may reduce air drag. By embedding several dimples 12 into the tread design of bicycle tires, the air flowing over the tire surface would become more turbulent, which may decrease the size of the wake region where low pressure drags the tire backward. This would be particularly beneficial for road racing bicycles where aerodynamic efficiency is crucial.

In some embodiments of the present invention, there are more than 30 dimples 12 on the tread 10 with the dimple depth around 0.05 to 1.5 mm, and radius around 0.4 to 5 mm. Preferably, there are more than 30 dimples 12 on the tread 10 with the dimple depth around 0.2 to 0.4 mm and radius around 1 to 3 mm.

While the description above focuses on rounded dimples 12, it is understood by those skilled in the art that the aerodynamic features on a tire's surface can also manifest as protrusions 13, as shown in FIG. 5B, or a combination of dimples 12 and protrusions 13.

Additionally, the application of dimples or protrusions is not limited to the tread 10 of the tire; these features can also be effectively integrated into the sidewalls 20 to reduce drag. Specifically, placing these aerodynamic enhancements on the tire sidewall 20 within the gap between the sidewall 20 and the rim wall 41 can reduce drag, thereby improving the aerodynamic profile of the entire wheel assembly.

The current invention is not confined to the rounded shape of these dimples 12 or protrusions 13. A person of ordinary skill in the art would appreciate that the aerodynamic elements can be designed in various geometric shapes such as triangular, square, hexagonal, elliptical, or other polygonal forms.

Although the embodiments illustrated in FIG. 1-4 depict versions featuring a hookless rim, it should be appreciated by those skilled in the art that the disclosed aerodynamic features are applicable to various other types of rims. These may include, but are not limited to, hooked rims, hookless rims, and tubular rims, which can vary in rim depth and be constructed from a variety of materials such as aluminum, carbon fiber, steel, and magnesium. This adaptability ensures that the aerodynamic improvements are not confined to a single rim type or material, thereby broadening the utility and application of the disclosed invention.

It is to be understood by a person of ordinary skill in the art that the present invention is applicable to a wide variety of constructions and construction materials, particularly to the constructions and materials disclosed in the referenced application. For instance, the tire may be configured as a tubeless tire featuring a two-ply construction. This versatility ensures that the inventive concepts disclosed herein can be adapted to different tire configurations and materials, thus expanding the potential applications and improving the utility of the invention by improving the rolling efficiency and the aerodynamics at the same time.

For example, the first layer may be made of nylon tire cord with 150-170 TPI and be turned up from the inside of the tire, around the beads, toward the outside of the tire, and ends at the first edges. The second layer may be made of monofilament cross-woven material and be turned up from the inside of the tire and beneath the first layer, around the beads, toward the outside of the tire, and ends at the second edges. The distance from the second edge to its nearest bead is the second turn-up height. In this case, the first edges may be covered by the second layer, and the second turn-up height may be around 10-30 mm. Because the second layer is made of monofilament material already, the tire does not need to have a chafer. In some cases, the tire may also have a protection layer located beneath the tire tread. Preferably, the protection layer is made of nylon, Vectran or aramid material with 60-200 TPI.

In traditional nylon tire cords, the spacing between adjacent wefts (weft spacing) typically ranges from 4 mm to 10 mm for tire cords with a thread count of 100 to 170 TPI (threads per inch). To enhance the tire's puncture resistance, the weft spacing may be reduced to 2 mm to 3.5 mm. In preferred embodiments, the weft spacing is 1.8-2.5 mm, and the material utilized is Nylon 66. This adjustment in weft spacing serves to improve the tire cord's ability to resist punctures and resulting in a more robust tire construction.

In some embodiments of the present invention, the reduction in weft spacing, aimed at enhancing puncture resistance, can be implemented in the first ply, the second ply, and/or within the puncture protection layer of the tire. This strategic placement of tighter weft spacing in one or more layers contributes to the overall structural integrity and durability of the tire, offering improved resistance to penetration from external objects.

A person of ordinary skill in the art would understand that the tighter weft spacing, as described, can be implemented independently, in conjunction with the previously stated aerodynamic enhancements, and/or combined with measures for reduced rolling resistance in the referenced application. This allows for a customizable approach to tire design, where various features can be selectively incorporated to achieve the desired balance of performance characteristics.

It is to be understood that, while the invention has been described in conjunction with the detailed description thereof, the foregoing description is intended to illustrate and not limit the scope of the invention, which is defined by the scope of the appended claims. Other aspects, advantages, and modifications are within the scope of the following claims. This application is intended to cover any variations, uses, or adaptations of the invention following the general principles outlined herein and including such departures from the present disclosure as come within known or customary practice within the art to which this invention pertains and may be applied to the essential features hereinbefore set forth and followed in the spirit and scope of the appended claims.

1. A bicycle tire, comprising:
a tire tread comprising at least ten dimples each having a depth between 0.1 mm and 0.3 mm and a size specification marking;
a sidewall with fewer than twelve venting flashes that has a height exceeding 2 mm, and a rim line with a height of less than 0.2 mm;
a wing-like structure of elastomeric material integrally formed with the sidewall, the wing-like structure projecting radially outward such that, when the bicycle tire is mounted on a rim, the structure occupies at least 40% of a space between the sidewall and a rim wall, the wing-like structure having a generally triangular cross-section with a base width of about 1-3.5 mm and a height of about 2-15 mm, and having a total weight between 7 grams and 60 grams; and
a bead comprising carbon fiber material with at least seven winds.
